(19) United States
(12) Patent Application Publication
(10) Pub. No.: US 2006/0236120 A1
(43) Pub. Date: Oct. 19, 2006

(54) Method and apparatus employing stress detection for highly secure communication

(75) Inventors: Scott Thomas Jones, Austin, TX (US); Frank Eliot Levine, Austin, TX (US); Robert John Urquhart, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/105,596

(22) Filed: Apr. 14, 2005

(51) Int. Cl. H04K 1/00

(52) U.S. Cl. 713/186

(57) ABSTRACT

A high security communication station delivers information to an authenticated user. The station receives encrypted information intended for a particular user. The station verifies the identity of the current user using the highly secure technology of retinal scan or iris scan in one embodiment. A detector checks physiological information of the current user to assure that the user currently exhibits no substantial stress that might indicate improper force or duress by a third party. Once the station authenticates the current user and assures that the current user exhibits no substantial stress, the station decrypts the received information and renders the information for secure delivery to the intended user, namely the authenticated current user. The station substantially co-locates the point of decryption with the point of information delivery. Integrating the point of decryption, the point of information delivery as well as the point of user authentication in the same structure dramatically reduces the possibility of information interception by an unauthorized party.

### CROSS REFERENCE TO RELATED APPLICATIONS

This patent application is related to the U.S. Patent Application entitled “Method and Apparatus For Highly Secure Communication”, inventors Scott Thomas Jones, Frank Eliot Levine and Robert John Urquhart, Attorney Docket No. AUS920040962US1 (S.N. to be assigned), filed on the same day as the subject patent application, and assigned to the same assignee, the disclosure of which is incorporated herein by reference in its entirety.

### TECHNICAL FIELD OF THE INVENTION

The disclosures herein relate generally to the communication of information to an information handling system (IHS) user and, more particularly, to the communication of information to an IHS user in a highly secure manner.

### BACKGROUND

Modern digital communication technology can transport vast quantities of information from point to point. Depending on the particular application, an information handling system (IHS) can receive and/or transmit many different types of information including, for example, text, photo images, audio, video and combinations thereof. Typical IHSs that communicate such information include desktop, laptop, notebook and server computers, personal digital assistants (PDAs), cell phones, pagers and other communication devices. However, these IHSs frequently do not transmit or receive information in a secure manner.

Unauthorized or unintended parties may intercept information sent to an IHS in a number of different ways. In some circumstances, an unauthorized party, may intercept information in the communication path leading to the IHS prior to reception by the IHS. For example, a communication network may include unsecured nodes at which an unauthorized party can intercept information in transit to a recipient IHS. Even if the information arrives at the intended recipient IHS without prior interception, an unauthorized party may still view the received information by surreptitiously observing the display screen of the IHS. Simply looking over the shoulder of the intended information recipient is one example of lack of security at the recipient IHS. Moreover, an unauthorized party may possibly overhear audio information during presentation of the audio information to the user of the recipient IHS.

Information handling systems may employ data encryption in the transmission path over a network to prevent meaningful interception. For example, the Data Encryption Standard (DES) provides a symmetric private key with a level of security varying according to the key length. Public key cryptography uses an asymmetric key pair including a public key and a corresponding private key. Each of these encryption techniques provides security to information still in the transmission path. However, once the recipient IHS decrypts the information, the IHS may present the decrypted information to the IHS user in an insecure manner. For example, the recipient IHS may present the information to the intended recipient in an audio and/or video form that both the intended recipient and others may hear or view. Once presented to the recipient user, many IHSs provide no further security. In other words, if the recipient places the IHS in an unsecured environment, unauthorized parties may gain access to the received information.

Other security problems also exist in systems that employ encryption in the communication path to the recipient IHS. An unauthorized or unscrupulous person may place the user of the recipient IHS under duress or otherwise force the user to decrypt the received information. Even though the authorized user of the recipient IHS properly decrypts the message, the unauthorized user obtains the decrypted message by force.

What is needed is a method and apparatus for communicating information to an IHS in a highly secure manner that addresses the problem of interception in the transmission path and interception by an unauthorized person placing the recipient IHS user under duress to obtain a decrypted message.

### SUMMARY

Accordingly, in one embodiment, a method is disclosed for communicating encrypted information to a recipient in a secure manner. The method includes identifying, by an identifier, a recipient as an authorized recipient. The method also includes detecting, by a detector, if the authorized recipient is currently being subjected to stress. The method also includes decrypting, by a decrypter, the encrypted information to provide decrypted information for presentation to the recipient. The decrypting step executes if 1) the identifier determines the recipient to be an authorized recipient, and 2) the detector determines the authorized recipient to be not currently subjected to stress. The method also includes rendering, by a rendering device, the decrypted information to the authorized recipient. In one embodiment, the identifying, detecting, decrypting and presenting steps are performed adjacent the recipient's body such that the decrypted information is prevented from being perceived by other than the authorized recipient.

In another embodiment, an information processing apparatus is disclosed for presenting information to a recipient in a secure manner. The apparatus includes a housing. The apparatus also includes a receiver, situated in the housing, that receives encrypted information. The apparatus also includes an identifier, situated in the housing and coupled to the receiver, that identifies a recipient as an authorized recipient. The apparatus further includes a detector, situated in the housing, that detects if the authorized recipient is currently being subjected to stress. The apparatus also includes a decrypter, situated in the housing, that decrypts the encrypted information to provide decrypted information. The apparatus further includes a rendering device, situated in the housing, that renders the decrypted information to the authorized recipient. The apparatus still further includes control logic, situated in the housing and coupled to the identifier, the detector, the decrypter and the rendering device. The control logic disables one of the decrypter and the rendering device if the detector finds that the authorized recipient is currently being subjected to stress.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of a one-way embodiment of the disclosed highly secure information delivery system.

FIG. 2A shows a side view of a goggle-shaped embodiment of the disclosed highly secure information delivery system.

FIG. 2B shows a top view of the goggle-shaped embodiment of FIG. 2A.

FIG. 3 shows a side view of a helmet-shaped embodiment of the disclosed highly secure information delivery system.

FIG. 4 shows a general purpose computer system that is configurable as a communication station in the disclosed highly secure information delivery system.

FIG. 5 shows a block diagram of a two-way embodiment of the disclosed highly secure information delivery system including two communication stations.

FIG. 6 shows a flow chart of the decryption and rendering methodology employed by the disclosed highly secure information delivery system.

FIG. 7 shows a flow chart of the encryption methodology employed by the disclosed highly secure information delivery system.

### DETAILED DESCRIPTION

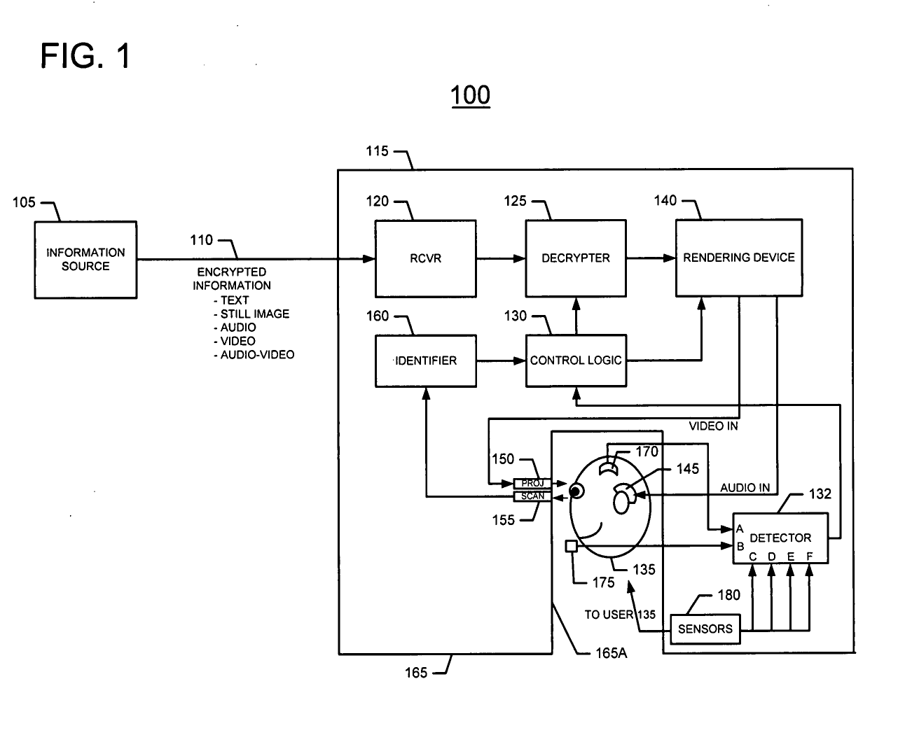

FIG. 1 depicts a block diagram of a representative information delivery system 100. System 100 includes an information source 105 that sends encrypted information over a transmission path 110 to a communication station or information handling system (IHS) 115. Transmission path 110 may include one or more network nodes (not shown). Moreover, transmission path 110 may include wire and/or wireless infrastructure to facilitate communication between information source 105 and IHS 115. In one embodiment, the Internet may form a portion of, or the entirety of, transmission path 110. The encrypted information transmitted on transmission path 110 may include encrypted text, encrypted still images, encrypted audio, encrypted video, encrypted audio-video and other combinations thereof. Transmission path 110 couples to a receiver 120 to supply the encrypted information to IHS 115. Receiver 120 may take the form of a wired or wireless network card that employs Ethernet or other communication protocols.

Receiver 120 couples to a decrypter 125 that decrypts the received encrypted information provided thereto by receiver 120. Decrypter 125 decrypts the received encrypted information when so commanded by control logic 130. More particularly, when IHS 115 positively identifies an authorized information recipient 135, then decrypter 125 commences decryption as explained later in more detail. In one embodiment, in addition to checking the identify of the prospective recipient 135, IHS 115 also performs a test to determine if the prospective recipient 135 exhibits signs of duress as explained in more detail below. Control logic 130 requires that both identifier 160 identifies the recipient 135 as the intended recipient and that detector 132 determines that the recipient does not exhibit evidence of duress before instructing decrypter 125 to decrypt the received message and instructing rendering device 140 to render the message to the recipient.

Decrypter 125 couples to a rendering device 140 to supply the decrypted information thereto. Rendering device 140 takes the raw decrypted information provided thereto by receiver 120 and renders or transforms that information into a form suitable for presentation to the authorized information recipient 135. Rendering device 140 couples to control logic 130 so that control logic 130 can instruct rendering device 140 to present decrypted information to recipient 135 when IHS 115 positively identifies the recipient as an authorized recipient. Without this positive identification, rendering device 140 does not transmit information to recipient 135. Moreover, control logic 130 assures that rendering device 140 does not transmit information to the recipient use 135 unless detector 132 indicates that the recipient user exhibits no measurable signs of duress or significant stress.

If the decrypted information contains audio information, then rendering device 140 supplies the audio information to an electro-acoustic transducer 145 placed on or adjacent to the ear of recipient 135. Rendering device 140 couples to transducer 145 as shown. Rendering device 140 converts the particular audio format provided thereto by decrypter 125 into audio signals suitable for reproduction by transducer 145. In one embodiment, system 100 employs a bone-conduction transducer as transducer 145 to prevent unauthorized parties nearby recipient 135 from overhearing annunciated information.

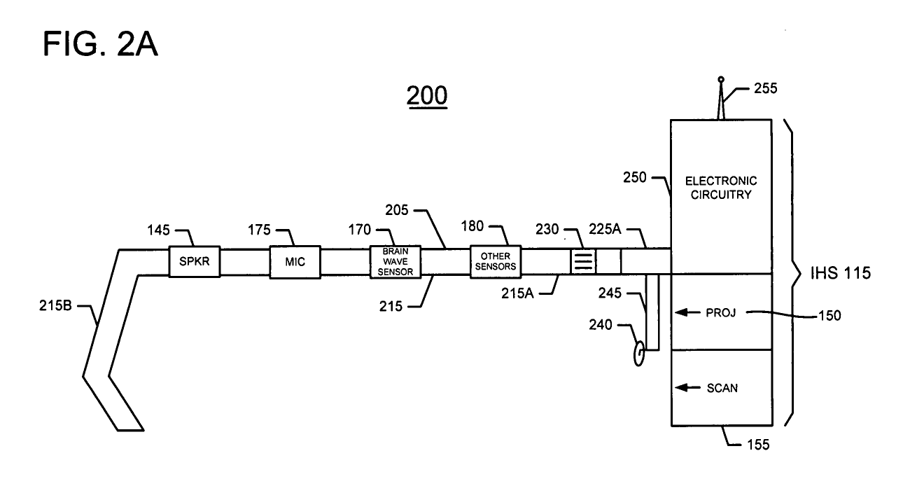

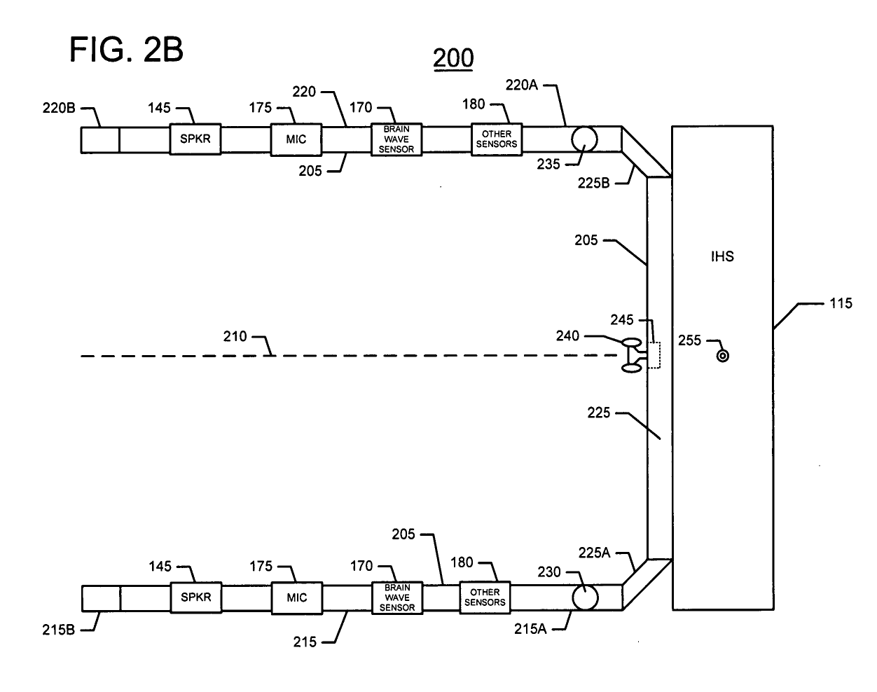

If the decrypted information contains video information, then rendering device 140 supplies the video information to a secure video display or projector 150 such as a liquid crystal display (LCD) panel or head up display (HUD) situated in close proximity to the user. Projector 150 and earphone 145 are considered to be part of rendering device 140 in that they render information to the user. In one embodiment, IHS 115 positions projector 150 so close to the eyes of recipient 135 that others cannot see the displayed information. In one embodiment, IHS 115 takes the shape and geometry of goggles or eye glasses worn by recipient 135 as shown in FIG. 2A. In one highly secure embodiment, projector 150 employs a retinal projector to directly project a video image on the retina of the authorized user. For purposes of this document goggles include eyeglasses. As miniaturization technology progresses, the teachings herein apply with equal force to smaller and smaller versions of the disclosed information delivery system.

To positively identify the authorized recipient user 135, system 1 15 includes a retinal scanner 155 to scan the retina of the user. Alternatively, system 115 employs an iris scanner to scan the iris of the user. The human eye's retina and iris exhibit highly unique characteristics. These highly unique characteristics permit the identification of a particular user with extremely high accuracy. To enable identification of user 135, identifier 160 couples to scanner 155 and control logic 130 as shown in FIG. 1. Identifier 160 includes or stores user 135's unique retina information or iris information. When user 135 presents his or her eye to scanner 155, scanner 155 sends scanned eye information to identifier 160. Identifier 160 attempts to match the scanned eye information of the current user with previously stored eye information of the intended user. If the scanned eye information of the current user matches the stored eye information in identifier 160, then identifier 160 sends a “User Verified” signal to control logic 130. When control logic 130 receives the “User Verified” signal, control logic 130 instructs decrypter 125 to decrypt the incoming received information. Moreover, when control logic 130 receives the “User Verified” signal, logic 130 instructs rendering device 140 to render the decrypted information into a form suitable for presentation to the authorized and now authenticated information recipient user 135. However, if the scanned eye information from scanner 155 fails to match the stored eye information in identifier 160, then identifier 160 sends a “Unauthorized User” signal to control logic 130. When control logic 130 receives the “Unauthorized User” signal, logic 130 disables, inactivates or turns off decrypter 125 and rendering device 140. Thus, when an unauthorized user presents his or her eye to scanner 155 for verification, the unauthorized user receives no decrypted information.

In an alternative embodiment, IHS 115 not only checks the identity of recipient user 135, but also performs a test to determine if the user exhibits signs of duress or stress. Such duress or stress may be caused by an unauthorized person threatening the user with physical force or subjecting the user to actual force. More particularly, if detector 132 finds that the user exhibits a sign or signs of duress, then control logic 130 disables, inactivates or turns off decrypter 125 and rendering device 140 in the same manner discussed above. Thus, this embodiment requires that two conditions exist prior to decryption of received information, namely 1) identification of the recipient 135 and 2) a determination that the recipient does not exhibits signs of duress.

To determine if user 135 exhibits a sign of duress or stress, detector 132 requires at least one source of stress indicating information. Many different types of known stress detectors, or combinations of stress detectors, can be employed is stress detector 132. Stress indication information includes physiological information such as voice information, brain wave information, respiration rate information, galvanic skin response information, reaction time and thermal image information, for example. In the particular example illustrated in FIG. 1, brain wave sensors 170 couple to detector input 132A to provide the user's brain wave information thereto. Microphone 175 also couples to detector input 132B to provide the user's voice information thereto so that detector 132 can analyze this voice information for evidence of stress or duress. Voice stress analyzers are known that analyze voice information for indications of stress. Such as voice stress analyzer can be employed in stress detector 132. Thus, in this example, both brain wave sensors 170 and microphone 510 provide physiological information to detector 132. Detector inputs 132C, 132D, 132E and 132F couple to other sensors, shown collectively as sensors 180, that collect other physiological information from user 135 to determine if user 135 currently exhibits signs of duress. These other sensors 180 include, but are not limited to, a heart rate sensor, a respiration rate sensor, galvanic skin response sensor, a reaction time sensor, a thermal image sensor and a blood circulation rate sensor, for example. IHS 115 couples these sensors to user 135 or positions these sensors sufficiently close to user 135 to collect the particular physiological information to which that particular sensor corresponds. Detector 132 analyzes one or more of the sensed physiological information streams to determine if user 135 currently exhibits signs of stress or duress. For example, detector 132 may analyze a user's heart rate and establish a heart rate base line over multiple sessions which, if exceeded in a current session, may indicate that user 135 is currently subjected to stress or duress.

If detector 132 finds that the user 135 currently exhibits signs of distress, then detector 132 so informs control logic 130. In response to such a positive stress determination, control logic 130 disables decrypter 125 and/or rendering device 140. However, if detector 132 determines that user 135 currently exhibits no substantial sign of stress, then detector 132 so informs control logic 130. In response to such a negative stress finding by detector 132, control logic 130 instructs decrypter 125 to decrypt and rendering device 140 to render, provided identifier 160 identifies user 135 as the authorized recipient of the received information.

In the above described embodiment, IHS 115 substantially co-locates the decrypter 125 and rendering device 140 within IHS 115. Moreover, identifier 160 is substantially co-located with decrypter 125 and rendering device 140 within IHS 115. Thus, IHS 115 includes a substantially co-located point of authentication, point of decryption and point of rendering. This arrangement makes it very difficult for unauthorized third parties to receive the information intended for authorized user 135. IHS 115 integrates the point of authentication, point of decryption and point of rendering within a common structure not accessible to unauthorized users. In another embodiment, IHS 115 substantially co-locates detector 132 with identifier 160, decrypter 125 and rendering device 140 within IHS 115. In another embodiment, IHS 115 integrates detector 132, identifier 160, decrypter 125 and rendering device 140 in a common structure, for example housing 165. In this manner, IHS 115 places detector 132, identifier 160, decrypter 125 and rendering device 140 in close proximity of the human body, namely recipient 135.

In FIG. 1, IHS 115 includes a substantially opaque or translucent housing 165 with an opening 165A sufficiently large to encompass the user's head, but not so large as to receive multiple heads, in one embodiment. The opaque or translucent character of housing 165 prevents others from seeing see through housing 165. In this particular embodiment, only one user may place the user's head in opening 165A at a time. Thus, a nearby unauthorized user can not see or hear what the authorized user sees and hears when the authorized user places his or her head in opening 165A. In one embodiment IHS 115 exhibits a configuration and geometry sufficiently small to take the form of a helmet, goggles or pair of eye glasses.

FIG. 2A shows a side view of information handling system 115 configured together with additional structures to form a pair of glasses or goggles 200 that the information recipient may wear. FIG. 2B shows a top view of goggles 200. Fig.'s 2A and 2B include several elements in common with FIG. 1. Like numbers indicate like elements when comparing FIGS. 2A and 2B with FIG. 1. Goggles 200 include a frame 205 that exhibits symmetry about center line 210 of FIG. 2B. Frame 205 provides a support structure or housing for other elements described below. Frame 205 includes a right ear frame member 215 and a left ear frame member 220. FIG. 2A shows a side view of right ear frame member 215. Right frame member 215 includes a front end 215A and a rear end 215B. Rear end 215B exhibits a curved shape that engages around the user's ear to hold goggles 200 in position on the user's head. Likewise, as seen in FIG. 2B, left ear frame member 220 includes a front end 220A and a rear end 220B that correspond with front end 215A and rear end 215B, respectively. Ear end 215B cooperates with ear end 220B to engage the user's ears and hold goggles 200 in position on the user's head. Right ear frame member 215 and left ear frame member 220 each include a loudspeaker 145, a microphone 175, a brain wave sensor 170 and other sensors 180.

Frame member 205 includes a center frame member 225 that includes opposed flanged ends 225A and 225B. Center frame member 225 attaches to IHS 115 to support IHS 115 in position on the user's head. Frame member 215 rotatably attaches to flanged end 225A via hinge 230. Frame member 220 rotatably attaches to flanged end 225B via hinge 235. A nose bridge 240 attaches to center frame member 225 via bridge mount 245 as seen in FIG. 2A. Nose bridge 240 engages the user's nose to support the goggles 200 on the user's head. In this particular embodiment, the IHS 115 located in goggles 200 includes three main sections, namely projector 150, scanner 155 and an electronic circuitry section 250 as seen in FIG. 2A. Electronic circuitry section 250 includes several structures from the IHS 115 of FIG. 1 now drawn collectively as electronic section 250 in FIG. 2 for convenience of illustration. More specifically, electronic circuitry section 250 includes receiver 120, decrypter 125, control logic, 130 detector 132, rendering device 140 and identifier 160. An antenna 255 couples to electronic circuitry section 250 to provide incoming wireless information signals to receiver 120 within electronic circuitry section 250. Speaker 145, microphone 175, brain wave sensor 170 and other sensors couple to electronic circuitry 150, projector 150 and scanner 155 via wires (not shown) within or adjacent frame members 215 and 220. Sensors 180 include wires (not shown) or other coupling apparatus appropriate to couple each sensor to the recipient user's body according to the particular physiological function sensed.

Frame 205 positions scanner 155 in a position with respect to the user's eyes such that scanner 155 may scan the user's eyes for unique retina or iris information. Scanner 155 transmits the scanned retina or iris information to electronic circuitry 250. Electronic circuitry 250 then compares the scanned eye information with previously stored eye information of the authorized user to determine if the current user is authorized to access encrypted information received by electronic circuitry 250 of goggles 200.

When identifier 160 of IHS 115 determines that the current goggle user is an authorized user, then identifier 160 so informs control logic 130. Also, when detector 132 determines that the authorized user currently exhibits no sign of significant duress or stress, detector 132 so informs control logic 130. In response to a proper identification and a no stress finding, control logic 130 instructs decrypter 125 to decrypt the encrypted information received by receiver 120. Decrypter 125 sends the decrypted information to rendering device 140. Rendering device 140 couples to projector 150 to provide projector 150 with rendered decrypted video information. Projector 150 displays this video information for viewing by the user of goggles 200. In one embodiment, for additional security, projector 150 employs a retinal projection mechanism so that only the user of googles 200 sees a video image. If audio information exists in the decrypted information, then rendering device 140 prepares that audio information for playback to the user by an electro-acoustic transducer, loudspeaker (SPKR) or earphone 145 situated in frame 205 as shown in FIG. 2A. In one embodiment, for additional security, transducer 145 employs a bone-conduction type speaker that transmits an audio signal to bones in the user's head. This significantly reduces the risk of nearby unauthorized parties overhearing decrypted audio information intended for the authorized user of goggles 200. In one embodiment, control logic 130 disables, inactivates or turns off both decrypter 125 and rendering device 140/projector 150 when either the detector 132 finds that the user exhibits signs of stress or identifier 160 fails to identify the user as the intended recipient.

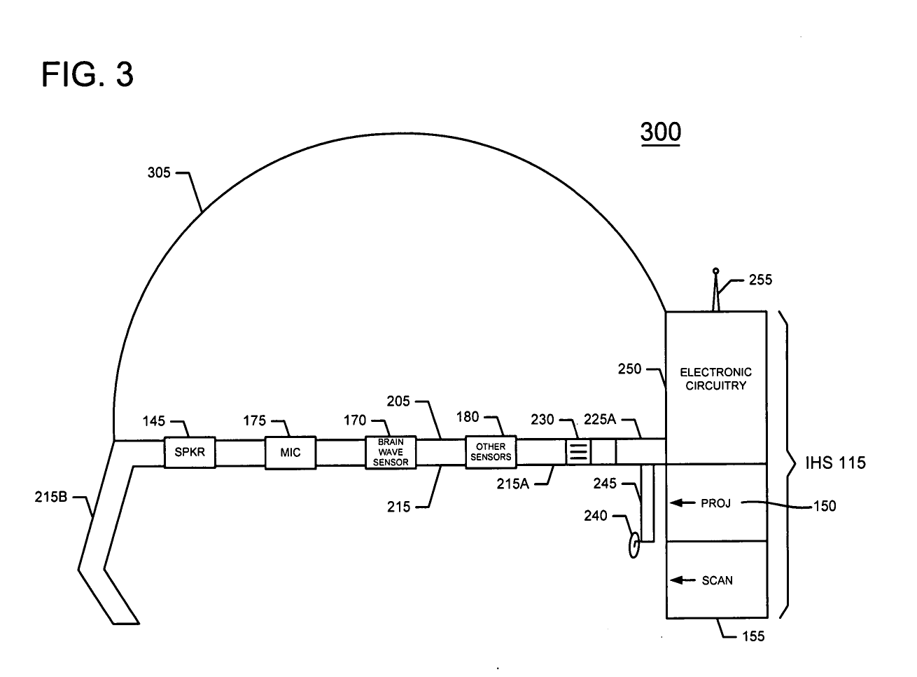

In an alternative embodiment, IHS takes the shape of a helmet 300 as shown in FIG. 3. In this particular arrangement, helmet 300 exhibits a configuration similar to goggles 200 of FIG. 2 except that helmet 300 includes a dome-shaped head covering 305. In comparing helmet 300 of FIG. 3 with googles 200 of FIG. 2, like numbers indicate like elements. IHS 115 may assume many different configurations and geometries in addition to the representative goggles and helmet geometries illustrated and described above. However, it is generally desirable that the point of decryption and the point of delivery be substantially co-located and located adjacent the user's body. For example as seen in FIG. 1, IHS 115 substantially co-locates the point of decryption, namely decrypter 125, and the point of delivery, namely projector 150, in the same structure, namely IHS 115. IHS 115 also substantially co-locates the point of authentication, namely scanner 155/identifier 160 with the point of decryption and point of delivery. Stated alternatively, IHS 115 substantially co-locates the points of authentication, decryption and delivery in the same structure.

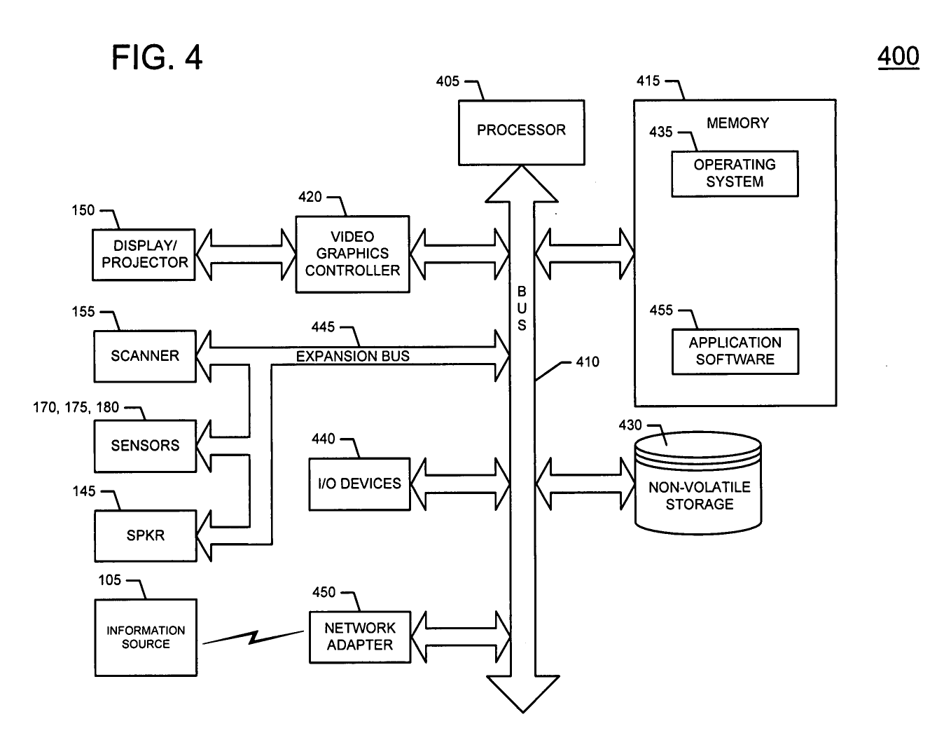

While information delivery system 100 of FIG. 1 employs a number of separate hardware function blocks such as receiver 120, decrypter 125, detector 132, rendering device 140, control logic 130, projector 150, scanner 155 and identifier 160 which function together as IHS 115, another embodiment employs a general-purpose computer system 400 for IHS 115 such as shown in FIG. 4. Computer system or IHS 400 includes application software 455 that programs system 400 to carry out the functions of the hardware function blocks already described above. Computer system 400 includes a processor 405. Bus 410 couples processor 405 to system memory 415 and video graphics controller 420. A display/projector 150 couples to video graphics controller 420. Nonvolatile storage 430, such as a hard disk drive, CD drive, DVD drive, FLASH memory or other nonvolatile storage couples to bus 410 to provide computer system 200 with permanent storage of information. An operating system 435 loads in memory 415 to govern the operation of IHS 400. I/O devices 440, such as a keyboard and a mouse pointing device, couple to bus 410 in one embodiment. The user may optionally remove these I/O devices for convenience during use of IHS 115. One or more expansion busses 445, such as USB, IEEE 1394 bus, ATA, SATA, PCI, PCIE and other busses, couple to bus 410 to facilitate the connection of peripherals and devices to computer system 400. A network adapter 450 couples to bus 410 to enable computer system 400 to connect by wire or wirelessly to network infrastructures such as network infrastructure 430 shown in FIG. 1.

Application software 455 programs computer system 400 to perform the functions discussed above for receiver 120, decrypter 125, detector 132, rendering device 140, control logic 130, projector 150, scanner 155 and identifier 160. Computer system 400 receives encrypted information from information source 105. In this particular embodiment, information source 105 couples to network adapter 450 via a wireless connection. General purpose computer system 400 employs retinal or iris scanner 155 to scan the eye of a user who places his or her eyes into scanner 155. System 400 compares the eye scan information received from scanner 155 with eye scan information previously stored in non-volatile storage 430. The eye scan information previously stored in non-volatile storage 430 corresponds to the eye scan information of an authorized user 135, namely the user or recipient entitled to access the encrypted information. If the previously stored eye scan information matches the eye scan information currently received from scanner 155, then system 400 identifies this particular user 135 as the authorized user entitled to access the information received from information source 105. If this match occurs, then system 400 decrypts the encrypted information received from information source 105 by network adapter 450. If the decrypted information contains video content, then system 400 provides decrypted video information to display or projector 150 for presentation to user 135. If the decrypted information contains audio content, then system 400 provides decrypted audio information to a transducer or loudspeaker 145 for presentation to user 135. In one embodiment, application software 455 implements the function of detector 132. Application software 455 reads sensed physiological information from sensors 170, 175 and 180 to determine if the user currently exhibits any significant sign of stress. If applications software 455 makes such a positive finding of stress, for example voice stress, this may indicate the use of force, threats or other duress on the user by an unauthorized party. In this embodiment, the programming of application software 455 disables decryption and projection/display functions when software 455 detects such stress or duress.

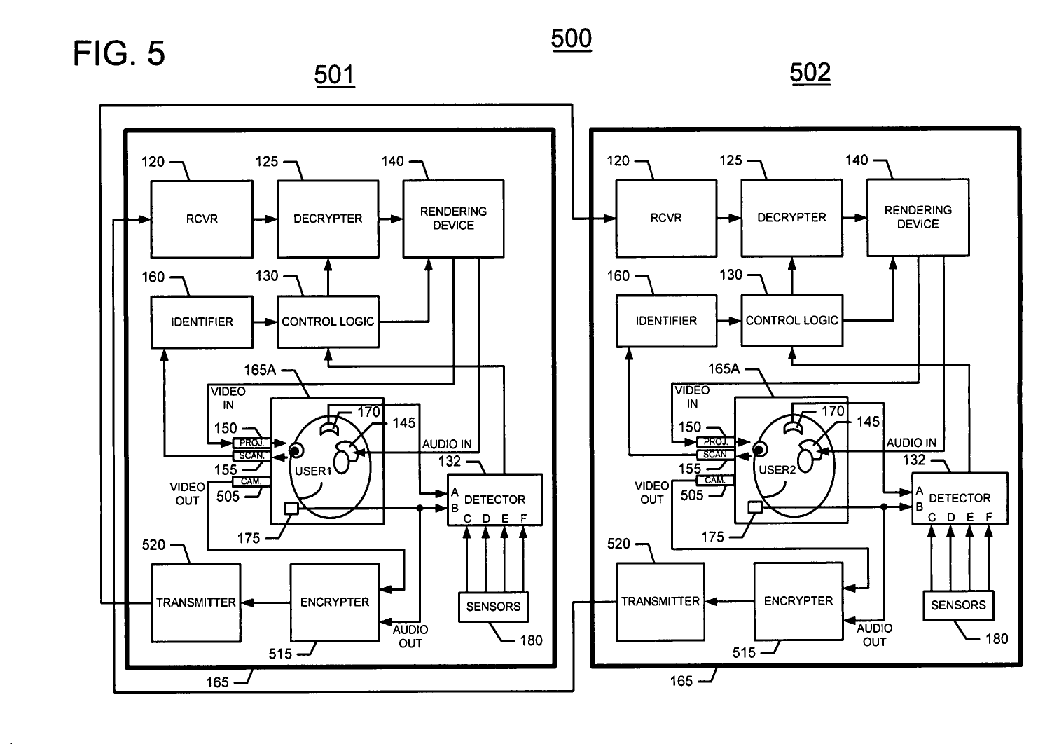

While FIGS. 1, 2 and 3 show a one way information delivery system 100 for securely receiving encrypted information, the disclosed methodology and apparatus also includes a two way information communication system 500 such as shown in FIG. 5. System 500 includes two substantially similar communication stations 501 and 502. Communication stations 501 and 502 each include two-way communication capabilities. The following discussion of representative communication station 501 applies to communication station 502 as well. Communication station 501 employs several elements in common with information delivery system 100 of FIG. 1. These common elements provide communication station 501 with the capability of receiving and decrypting encrypted information. For example, communication station 501 employs receiver 120, decrypter 125, detector 132, rendering device 140, control logic 130, identifier 160, display projector 150 and the scanner 155 from information and delivery system 100 of FIG. 1. These elements operate in substantially the same manner as already described above to receive encrypted information from communication station 502. However, communication station 501 includes additional circuitry to enable transmission of encrypted information derived from the user of communication station 501, namely USER1, to the user of communication station 502, namely USER2. More specifically, in addition to audio microphone 175 communications station 501 includes a video camera 505. Video camera 505 and microphone 175 supply video and audio information, respectively, to encrypter 515 of station 501. Encrypter 515 then encrypts that video and audio information with the public key of the intended recipient, USER2. Communication station 501 includes a transmitter 520 that transmits the encrypted video and audio information to communication station 502 via a wired or wireless link. As shown in FIG. 5, transmitter 520 of communication station 501 couples to receiver 120 of communication station 502.

In a manner similar to communication station 501 discussed above, communication station 502 also includes additional circuitry to enable transmission of encrypted information derived from the user of communication station 502, namely USER2, to the user of communication station 501, namely USER1. More specifically, like communication station 501, communication station 502 includes a video camera 505, audio microphone 175, an encrypter 515 and a transmitter 520. Video camera 505 and audio microphone 175 supply video and audio information, respectively, from USER2 to encrypter 515 of station 502. Encrypter 515 of communication station 502 then encrypts the video and audio information with the public key of the intended recipient, USER1, the user of communication station 501.

Both communication station 501 and 502 decrypt received signals in substantially the same manner as already discussed above with respect to information delivery system 100 of FIG. 1. When communication station 501 sends encrypted signals to communication station 502, station 501 encrypts those signals with the public key of the user of station 502, namely USER2. Communication station 502 stores the private key of its USER2 in its decrypter 125 or other storage location therein. Station 502 receives the encrypted information from station 501. The identifier 160 in station 502 compares USER2's current eye information received from scanner 155 with previously stored USER2 eye information. If the current eye information matches the stored eye information, then identifier 160 in station 502 instructs decrypter 125 to decrypt the encrypted information received from station 501 via receiver 120 in station 502. To decrypt the received encrypted information, decrypter 125 employs the previously stored private key of USER2. And thus, in response to identifier 160's verification or authentication of USER2, decrypter 125 decrypts the received information and provides the decrypted information to rendering device 140 in station 502. If the decrypted information includes video information, rendering device 140 processes that video information and provides processed video information to projector 150 in a form suitable for display to USER2. If the decrypted information includes audio information, rendering device 140 processes that audio information and provides processed audio information to transducer or ear phone 145 in a form suitable for annunciation by ear phone 145.

Returning now to identifier 160 of station 502, if identifier 160 finds no match between the current scanned eye information of USER2 and the stored eye information, then station 502 designates the user as unauthorized. In this event, identifier 160 of station 502 does not instruct decrypter 125 to decrypt the incoming received information from station 501. Moreover, identifier 160 does not instruct rendering device 140 to render information for display to, or hearing by, USER2. The unauthorized, unauthenticated user of station 502 receives no decrypted information.

In one embodiment, prior to decrypting and rendering the received information to the authorized user, namely USER2, detector 132 of communication station 502 senses one or more physiological condition of USER2 to determine if USER2 currently exhibits signs of substantial stress. If detector 132 determines that USER2 currently exhibits signs of such stress, then control logic 130 does not permit decryption of received information by decrypter 125. Moreover, in response to such a positive finding of stress, control logic 130 disables, inactivates or turns off rendering device 140. Again, the unauthorized, unauthenticated user of station 502 receives no decrypted information.

Now, before transmitting information in the opposite direction to station 501, station 502 encrypts the information with the public key of USER1. Station 501 receives the encrypted information from station 502. Station 501 decrypts the encrypted information in substantially the same manner described above wherein station 502 receives and decrypts encrypted information received from station 501. However, in this scenario, decrypter 125 of station 501 uses the private key of USER1 to decrypt information intended for USER1 and received from station 502. The decryption of information encrypted with the public key of USER1 occurs after identifier 160 of station 501 authenticates USER1 at station 501. In one embodiment, control logic 130 of station 501 permits such decryption only after detector 132 of station 501 determines that USER1 currently exhibits no sign of significant stress. System 500 can send questions to USER1 and detector 132 can indicate whether USER1 answers such questions truthfully or deceptively. If detector 132 detects that USER1 currently exhibits significant stress when answering these questions, this may indicate that USER1 is lying. In this event, control logic 130 does not permit decryption or rendering of information received by receiver 120 of communication station 501.

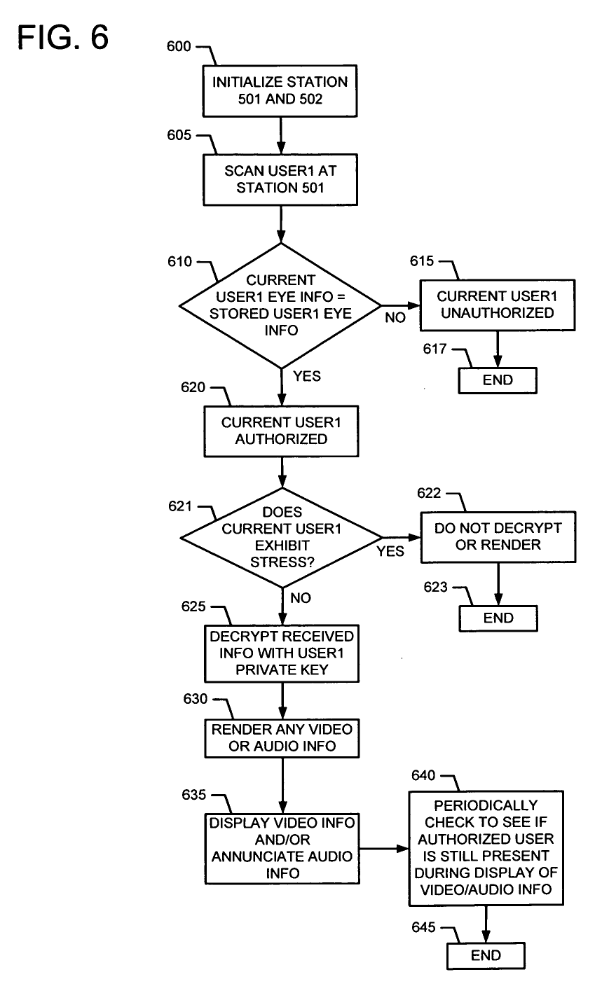

FIG. 6 shows a flowchart that depicts process flow when a representative station 501, operated by USER1, decrypts information intended for USER1 that station 502 encrypted and transmitted to station 501. When system 501 employs a general purpose computer system or information handling system (IHS) such as IHS 400 to act as station 501, application software 455 in IHS includes the appropriate programming needed to carry out the method steps now described in this flowchart. Process flow starts when communication station 501 and 502 initialize as per block 600. Station 501 then performs a retinal scan or iris scan of the user who currently operates station 501 as per block 605. This retinal scan yields unique eye information corresponding to the user of station 501. As mentioned earlier, station 501 stores the unique eye information of the intended user, namely USER1. Identifier 160 of station 501 performs a comparison between the current scanned eye information and the stored eye information for the intended USER1 as per block 610. If identifier 160 determines that the current eye information does not compare identically or substantially identically with the stored eye information, then station 501 rejects the current user as per block 615 and the process ends at block 617. In other words, in this scenario station 501 designates the current user as an unauthorized user and the process ends. Station 501 permits no decryption or rendering of received information for such an unauthorized user.

However, if identifier 160 determines that the current eye information compares identically or substantially identically with the stored eye information for the intended USER1, then station 501 designates the current user as an authorized user, namely USER1, as per block 620. In this event, test block 621 performs a test to determine if USER1 currently exhibits signs of stress. If stress is found, station 501 prevents decryption and rendering, as per block 622. The process then ends at block 623. However, if station 501 finds no stress, then station 501 permits decryption and rendering of the received information for the authorized user. Stepping back briefly in time, recall that prior to sending information to station 501, encrypter 515 of station 502 encrypts that information with the public key of USER1. Thus, the information received by receiver 120 of station 501 consists of information encrypted with the public key of USER1. Since, as discussed above, station 501 found the current user to be the authorized user not subjected to stress, decrypter 125 of station 501 decrypts the received information with the private key of USER1 as per block 625. Next, rendering device 140 renders any decrypted video information into video information suitable for display by projector 150, as per block 630. Moreover, rendering device 140 renders any decrypted audio information in an audio format suitable for annunciation by transducer or earphone 145 in station 501, also as per block 630. Projector 150 then displays the rendered video information and transducer 145 then annunciates the rendered audio information, as per block 635. While projector 150 and transducer 145 display and annunciate the decrypted information, identifier 160 of station 501 periodically checks to assure the continued presence of the authorized user at station 501 as per block 640. If the authorized user leaves station 501, then decrypting and rendering ceases. The process ends at block 645 when annunciation of the decrypted information to the user is complete. Station 501 then waits for the next message for its user.

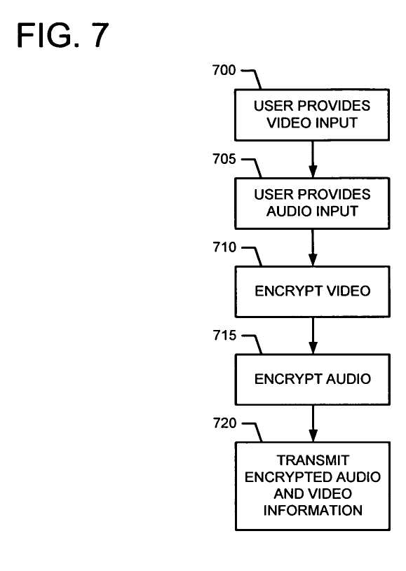

FIG. 7 shows a flowchart that depicts process flow when a representative station 501, operated by USER1, encrypts information and transmits the encrypted information to station 502, operated by USER2. Video camera 505 of station 501 takes full-motion video or video photographs of USER1, as per block 700. Video camera 505 supplies the resultant video information to encrypter 515. Audio microphone 510 supplies audio information from USER1 to encrypter 515, as per block 705. Encrypter 515 encrypts this video and audio information, as per blocks as 710 and 715, respectively, thus providing encrypted information to transmitter 520. Transmitter 520 of station 501 then transmits the encrypted video and audio information to station 502, either by wire connection or wirelessly, as per block 720. Station 502 then receives the encrypted signals from station 501. In a manner similar to that discussed above in the flowchart of FIG. 6 with reference to station 501, station 502 likewise attempts to authenticate its USER2. Upon such authentication of USER2, and determination that USER2 currently does not exhibit stress, station 502 decrypts information received from station 501 with the private key of USER2. Station 502 then renders the decrypted information and presents the decrypted information to the authenticated user, USER2.

Those skilled in the art will appreciate that the methodology disclosed, such as seen in the flow charts of Fig.'s 6 and 7 can be implemented in hardware or software. Moreover, the disclosed methodology may be embodied in a computer program product, such as a media disk, media drive or other storage media, or may be divided among multiple computer program products.

In one embodiment, the disclosed methodology is implemented as an application 455, namely a set of instructions (program code) in code modules which may, for example, be resident in the system memory 415 of system 400 of FIG. 4. As explained above, system 400 may be employed to authenticate a user, detect stress, decrypt information, and render the decrypted information in a form perceivable by the authenticated user. In one embodiment, system 400 performs this authentication, stress detection, decryption and rendering in close proximity to the user or recipient as explained above. In another embodiment, system 400 substantially co-locates the authentication, stress detection, decryption and rendering processes close to the user's body to avoid interception by unauthorized persons.

System 400 may also encrypt information for transmission to a user of another similar communication station or system 400. In one embodiment, system 400 carries out this encryption process in close proximity to the user. In another embodiment, system 400 substantially co-locates the authentication, stress detection, decryption, rendering, and encryption processes close to the user to avoid interception by unauthorized persons. Until required by system 400, the set of instructions or program code may be stored in another memory, for example, non-volatile storage 430 such as a hard disk drive, or in a removable memory such as an optical disk or floppy disk, or downloaded via the Internet or other computer network. Thus, the disclosed methodology may be implemented in a computer program product for use in a computer such as system 400. It is noted that in such a software embodiment, code which carries out the functions described in the flowcharts of Fig.'s 6 and 7 may be stored in RAM or system memory 415 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses a high security communication station which delivers information to an authenticated user. The station receives encrypted information intended for a particular user. The station verifies or authenticates the identity of the current user using a highly secure retinal scan or iris scan in one embodiment. The station also determines if the user exhibits signs of stress, for example voice stress. Once the station authenticates the current user and finds no significant stress exerted upon the current user, the station decrypts the received information and renders the decrypted information for secure delivery to the intended recipient, namely the authenticated current user. The station's configuration provides a point of decryption substantially co-located with the point of information delivery near the user's body. Integrating the point of decryption with the point of information delivery in the same structure dramatically reduces the possibility of information interception by unauthorized parties. Moreover, substantially co-locating the point of authentication with the point of decryption, the point of delivery and the point of stress detection, further reduces the likelihood of interception.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method in a data processing system of communicating encrypted information to a recipient in a secure manner, the method comprising:
identifying, by an identifier, a recipient as an authorized recipient;
detecting, by a detector, if the authorized recipient is currently being subjected to stress;
decrypting, by a decrypter, the encrypted information if the identifier determines the recipient to be an authorized recipient and the detector determines that the authorized recipient is not currently being subjected to stress, thus providing decrypted information; and
rendering, by a rendering device, the decrypted information to the authorized recipient;
the identifying, detecting, decrypting and presenting steps being performed adjacent the recipient's body such that the decrypted information is prevented from being perceived by other than the authorized recipient.

2. The method of claim 1, wherein the detecting step comprises sensing, by a physiological data sensor, physiological data of the recipient.

3. The method of claim 2, wherein the physiological data sensor senses one of voice information, brain wave information, respiration rate information, galvanic skin response information, thermal image information and reaction time information of the recipient.

4. The method of claim 1, further comprising disabling, by control logic, the decrypter if the detector detects that the recipient is currently being subjected to stress.

5. The method of claim 1, further comprising disabling, by control logic, the rendering device if the detector detects that the recipient is currently being subjected to stress.

6. The method of claim 1, wherein the identifying step further comprises periodically checking, by the identifier, the identity of the recipient to determine if the authorized recipient is still present at the identifier.

7. The method of claim 6, further comprising disabling, by control logic, the decrypter if the identifier determines that the authorized recipient is no longer present at the identifier.

8. The method of claim 6, further comprising disabling, by control logic, the rendering device if the identifier determines that the authorized recipient is no longer present at the identifier.

9. An information processing apparatus for presenting information to a recipient in a secure manner, the apparatus comprising:
a housing;
a receiver, situated in the housing, that receives encrypted information;
an identifier, situated in the housing and coupled to the receiver, that identifies a recipient as an authorized recipient;
a detector, situated in the housing, that detects if the authorized recipient is currently being subjected to stress;
a decrypter, situated in the housing, that decrypts the encrypted information to provide decrypted information;
a rendering device, situated in the housing, that renders the decrypted information to the authorized recipient; and
control logic, situated in the housing and coupled to the identifier, the detector, the decrypter and the rendering device, that disables one of the decrypter and the rendering device if the detector finds that the authorized recipient is currently being subjected to stress.

10. The information processing apparatus of claim 9, wherein the control logic disables both the decrypter and the rendering device if the detector finds that the authorized recipient is currently being subjected to stress.

11. The information processing apparatus of claim 9, wherein the detector detects physiological data of the recipient, the physiological data including one of voice information, brain wave information, respiration rate information, galvanic skin response information, thermal image information and reaction time information of the recipient.

12. The information processing apparatus of claim 9, wherein the housing comprises one of a goggles structure and a helmet structure.

13. The information processing apparatus of claim 9, wherein the identifier comprises one of a retinal scanner and an iris scanner.

14. The information processing apparatus of claim 9, wherein the rendering device comprises one of a retinal projector, a head up display (HUD) and an LCD.

15. The information processing apparatus of claim 9, wherein the encrypted information is encrypted using a first key of a key pair and the decrypter employs a second key of the key pair to decrypt the encrypted information.

16. The information processing apparatus of claim 9, wherein the decrypter decrypts the encrypted information in response to the identifier identifying a recipient as the authorized recipient and the detector finding that the authorized recipient is not currently subjected to stress.

17. A computer program product stored on a computer operable medium for communicating encrypted information, the computer program product comprising:
instructions for identifying, by an identifier, a recipient as an authorized recipient;
instructions for detecting, by a stress detector, if the authorized recipient is currently being subjected to stress;
instructions for decrypting, by a decrypter, the encrypted information to provide decrypted information for rendering to the recipient, if the recipient is an authorized recipient that is determined by the stress detector to not be currently subjected to stress; and
instructions for rendering, by a rendering device, the decrypted information to the authorized recipient;

18. The computer program product of claim 17, wherein the decrypting is prevented, by the instructions for detecting, if the authorized recipient is currently being subjected to stress.

19. The computer program product of claim 17, wherein the rendering is prevented, by the instructions for detecting, if the authorized recipient is currently being subjected to stress.

20. The information processing apparatus of claim 19, wherein the instructions for detecting analyze physiological data of the recipient, the physiological data including one of voice information, brain wave information, respiration rate information, galvanic skin response information, thermal image information and reaction time information of the recipient.
